(19) United States
(12) Patent Application Publication
(10) Pub. No.: US 2004/0228408 A1
(43) Pub. Date: Nov. 18, 2004

(54) Process and device for decoding and displaying of MPEG pictures in fast forward mode, video driver circuit and decoder box incorporating such a device

(75) Inventor: Frederic Roelens, Paris (FR)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: STMICROELECTRONICS SA, MONTROUGE (FR)

(21) Appl. No.: 10/742,602

(22) Filed: Dec. 19, 2003

(30) Foreign Application Priority Data
Dec. 20, 2002 (FR) 0216327

(51) Int. Cl. H04N 7/12

(52) U.S. Cl. 375/240.12; 375/240.01; 375/240.25

(57) ABSTRACT

A process for the decoding and displaying in forward mode at a theoretical speed xN of pictures coded according to the MPEG standard applies decoding and display rules, according to the value of a delay of the pictures displayed with respect to theoretical pictures specified by display at theoretical speed, according to specified thresholds (N1, N2, N3, N4).

### CROSS-REFERENCE TO RELATED APPLICATIONS

This application is based upon and claims priority from prior French Patent Application No. 0216327, filed on Dec. 20, 2002 the entire disclosure of which is herein incorporated by reference.

### FIELD OF THE INVENTION

The present invention generally relates to the decoding and to the displaying of audiovisual programs contained in a stream of compressed digital data.

### BACKGROUND OF THE INVENTION

It finds applications in video decoders comprising a personal digital recording functionality (PVR, standing for “Personal Video Recorder”). In such decoders, a recording of programs is made on a mass storage digital medium (or DSM, standing for “Digital Storage Media”) such as a hard disk, a digital videocassette, a DVD (“Digital Versatile Disk”), and more.

The decoders concerned are in particular decoder boxes (“Set-Top Boxes”) catering for the interface between an inlet for digital signals broadcast in real time by satellite, by cable or by terrestrial digital broadcasting (or DVB, standing for “Digital Video Broadcasting”) on the one hand, and an analog television on the other hand. Such a decoder box is a standalone apparatus. However, the invention applies also to integrated decoders built into a digital television, or to a digital read/record apparatus such as a DVD reader, a digital video cassette reader or the like.

A decoder box receives one or more programs in the form of a stream of compressed digital data, that is to say whose video frames (i.e. pictures) and audio frames are coded in such a way as to reduce the volume of the data broadcast. For example, this coding complies with the specifications of the MPEG-2 standard (ISO/IEC 13818-2) hereinafter the MPEG standard (“Motion Pictures Expert Group”). This standard defines a data compression technique for the coding of moving pictures and sound (in particular for digital television).

In the present description, the term “presentation”, when it is used in relation to a program, denotes the restoring of the decoded audio and video data, in audible and visible form respectively by a user. The term “playback” (or “reading”), used in relation to a program, more specifically denotes the decoding and the displaying of the program from a recording of the program on a hard disk. The term display is more particularly used to designate the presentation of the video frames.

The hard disk makes it possible to offer a number of functionalities, in particular the implementing of advanced modes of playback (or “trick modes”), that is to say reading at a speed different from a nominal forward speed (x1), in particular fast forward and rewind at high speed or otherwise.

Forward display at a nominal speed (x1), signifies that a frame, that is to say a picture, is displayed at each vertical synchronization event (hereinbelow VSYNC) of the display device, in the forward order of display of the pictures. Display at a speed x2 signifies in theory that if at a VSYNC, the frame of rank n is displayed, then at the next VSYNC the frame of rank n+2 is displayed, the ranks referring here to the forward order of display of the pictures at the nominal speed (x1). This skip in the pictures displayed gives an impression of reading at accelerated speed. More generally at a speed xN, where N is a number strictly greater than 0, the frame of rank N with respect to the previously displayed frame is in theory displayed at each VSYNC. Stated differently, theoretically one picture out of N is displayed.

The problems encountered in the implementation of fast forward display are in part related to the very construction of an MPEG stream. Specifically, displaying a picture every N pictures nevertheless requires that the entire set of data be processed, since the structure of the streams is not fixed. This does not amount simply to ignoring the pictures which are not to be displayed, since only the I pictures within the meaning of the MPEG standard contain the entire set of information required for their decoding.

Thus, to display a P picture within the meaning of the MPEG standard, for example, it is sometimes necessary to decode numerous earlier pictures. Hence the decoder must in theory be able to decode the entire set of pictures faster in order to display at a speed greater than x1.

Moreover, forward display at accelerated speed highlights the limitations in terms of processing speed, bit rate or access time of the entire set of constituent elements of the decoder box. The possible limiting elements are thus the MPEG decoder as has just been seen, but also the disk to which accesses will be multiplied, the demultiplexer, the descrambler and the interface with the card containing the descrambling keys, in the case of multiplexed and/or scrambled stored data.

Thus, to carry out fast forward display at the speed xN demands in practice a number of workarounds as compared with theoretical rule which is to display one picture out of N, at each VSYNC event. The methods according to the prior art propose that only the type I pictures be displayed, or that the current picture be frozen for as long as the picture which ought theoretically to be displayed has not been decoded. However, these methods are not completely satisfactory. In particular, the second case is equivalent to limiting the entire procedure to the speed of the slowest element of the decoder box.

According what is needed is a method and system to over come the problems encountered in the prior art and to optimize the displaying of the pictures at a selected speed according to the performance of the data stream processing chain, from the extracting of the data from the hard disk, up to display.

### SUMMARY OF THE INVENTION

A first aspect of the invention provides a method for forward decoding and displaying in forward mode at a specified theoretical speed xN, where N is a number greater than zero corresponding to a factor of speed of display with respect to a nominal speed x1, of pictures coded according to the MPEG standard comprising type I pictures and type P and/or B predicted pictures which are stored on a mass storage digital medium in the form of a compressed data stream corresponding to a specified audiovisual program. These steps are carried out in order to decide which are the pictures to be decoded and displayed, and consist in:

evaluating in real time at specified respective display instants, a delay of the pictures displayed with respect to theoretical pictures specified by display at the theoretical speed, and

if the delay is less than a first specified threshold, decoding all the pictures of the data stream;

and if the delay is greater than the first threshold, no longer decoding at least some of the predicted pictures of the data stream; and

at each display instant, displaying that one of the decoded pictures which are available for display and come before theoretical picture corresponding to the display instant in the order of display of the pictures at the nominal speed, which is the closest to the theoretical picture according to the order of display.

An exemplary calculation of the delay in display for the decoded pictures relative to theoretical speed is set forth hereinbelow.

It should be noted that, with the aim of generalization, the description here is from the picture standpoint, but that the process applies in the same manner to each field of a picture in the case of an interleaved display system.

Let us consider the case where the predicted pictures comprise type B pictures. If the delay is greater than the first threshold, the process advantageously provides that the predicted pictures of type B no longer be decoded and hence no longer be displayed. Carrying out skips of size equal to the decoding and display time for a type B picture makes it possible to correspondingly decrease the display delay with respect to theoretical speed, without disturbing the decodings of the other pictures since no picture is predicted from the type B pictures.

Preferably, if the delay is greater than a second threshold which is greater than the first threshold, at least some of the type P predicted pictures, and the pictures predicted from the type P pictures, are also no longer decoded and hence no longer displayed. Not decoding a type P picture makes it effectively impossible to decode the type B and type P pictures which are predicted from this type P picture. This occurs if the skipping of the type B pictures is not sufficient to maintain the delay below the second threshold.

Advantageously, if the delay is greater than a third threshold which is greater than the second threshold, only the type I pictures are decoded and hence displayed. Stated otherwise, the predicted pictures are no longer decoded.

Preferably, if the delay is greater than a fourth threshold, which is greater than the third threshold, a forward skip is performed in the compressed data stream.

These rules make it possible to decode the greatest possible number of pictures according to the performance of the various constituent elements of the processing chain of the decoder box, while avoiding excessive deviations from theoretical speed.

In an advantageous mode of implementation, the display delay is defined as a number of pictures' worth of delay, taking as reference a virtual time base clamped with regard to vertical synchronization events (VSYNC) of the display, and comparing at each of these events the picture displayed with that which ought to be displayed according to theoretical speed xN.

Preferably, the number of bytes of the digital data stream which are forward skipped in the data stream if the delay is greater than the fourth threshold is determined on the basis of the number of pictures' worth of delay and of the mean bit rate of the reading of the compressed data stream from the mass storage digital medium. More precisely, it is determined as the product of these two quantities. This makes it possible to partly overcome the fact that the location of the pictures is not known in the compressed data stream. Specifically, such a skip in the reading of the data from the digital medium makes it possible to approximately compensate for the delay noted, although the latter is expressed as a number of units (images), which does not correspond directly to the organization of the data on the medium.

Advantageously, the virtual time base is defined by a parameter equal to theoretical number of past pictures per vertical synchronization event of the display. For example, if theoretical speed is x2, theoretical number of past pictures per VSYNC is 2 pictures (instead of one picture per VSYNC in the case of the nominal speed x1). The virtual time base thus defined has a frequency twice as high as the time base of the instants of display. Furthermore, it will be noted that for operations such as “image freeze” or “image by picture advance”, the parameter will be equal to zero and to unity respectively.

Preferably, theoretical speed of display is controlled by a user, and may be the nominal display speed or an accelerated or decelerated display speed with respect to the nominal speed. The user's command can be effected for example by way of a remote control. Other cases may be envisaged, in particular in Video On Demand (VOD) applications, where the user can have access before any payment, to a high-speed presentation of the programs that he may buy.

In an advantageous implementation of the method, which is the subject of the invention, the parameter equal to theoretical number of past pictures per vertical synchronization event is a fraction of the type M/Q where M and Q are integers and where the fraction M/Q is reduced. Specifically, by working with integers, rather than real numbers, it is possible to reduce the propagation and accumulation of rounding errors. For example, for an NTSC screen, it will be preferred to consider the display frequency to be equal to the quotient 30 000/ 1001 Hz. Moreover, by considering a fraction, which is reduced, it is possible to lessen the processing according to the process of the invention. For example, for a theoretical display speed of 4/2, the process is optimized if the virtual time base is considered to be two past pictures per VSYNC, rather than four past pictures every two VSYNCs. It should be noted that no assumption is made regarding the speed at which the data are supplied as input to the MPEG decoder, or with regard to the structure of the groups of pictures (GOPs) within the meaning of the MPEG standard. For example, if a stream comprises only I type pictures and P type predicted pictures, it is sufficient to give equal values to the first and to the second thresholds.

A second aspect of the invention pertains to a device comprising means for the implementation of the above process.

A third aspect of the invention pertains to a video driver circuit comprising a device according to the second aspect.

A fourth aspect of the invention relates to a decoder box (set-top box) comprising a video driver circuit according to the third aspect.

The present invention has been shown to be used advantageously for video decoders comprising a personal digital recording functionality (PVR, standing for “Personal Video Recorder”). In such decoders, a recording of programs is made on a mass storage digital medium (or DSM, standing for “Digital Storage Media”) such as a hard disk, a digital videocassette, a DVD (“Digital Versatile Disk”), and more.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings in which:

FIG. 1 is a diagram which depicts a device for the implementation of the invention;

FIG. 2 is a schematic diagram depicting the steps of the method according to one mode of implementation of the method of the invention;

FIG. 3 is a diagram illustrating an exemplary GOP within the meaning of the MPEG standard, and the prediction links between various pictures of the GOP;

FIG. 4 is an array illustrating coded pictures present in a data stream portion contained in a buffer memory after reading from the mass storage digital medium;

FIG. 5 is an array containing the same pictures as those of FIG. 4 onwards of a given picture, and ordered according to the forward order of display at the nominal speed;

FIG. 6 is a graph representing along the abscissa the events of the display time base (VSYNC) and along the ordinate the delay evaluated at various instants of display, in an exemplary implementation of the method of the invention.

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

Let us firstly recall a few concepts used in the MPEG standard. Firstly, the type I, P or B of the coded pictures is defined as follows:

a picture of I (intra) type or I picture is a picture coded without reference to another picture and for which all the information required for decoding is contained in the picture itself;

a picture of P (predicted) type or P picture is a picture which must be decoded by using the information relating to an earlier I or P reference picture according to the forward order of display (hereinafter, we shall refer to a P picture predicted from an I picture as a “once predicted P picture”, to a P picture itself predicted from a once predicted P picture as a “twice predicted P picture” and more generally to a P picture as an “n times predicted P picture” when it is predicted from an I picture via n−1 P pictures;

a picture of B (bidirectional) type or B picture is a picture which must be decoded by using information relating to an earlier or later first and second reference picture (I and/or P) according to the forward order of display.

Consequently, the pictures form elementary groups which are decodable independently of the other elementary groups. A group of pictures, that is to say a GOP, within the meaning of the MPEG standard can contain several of these elementary groups. In fact, it turns out however that a GOP comprises at most one elementary group. B bidirectional pictures can be interpolated between pictures of these elementary groups, then constituting a broken link within the meaning of the standard.

Direct access points associated with start-up codes (sequence codes and sequence extension codes) characterize the start of these elementary groups.

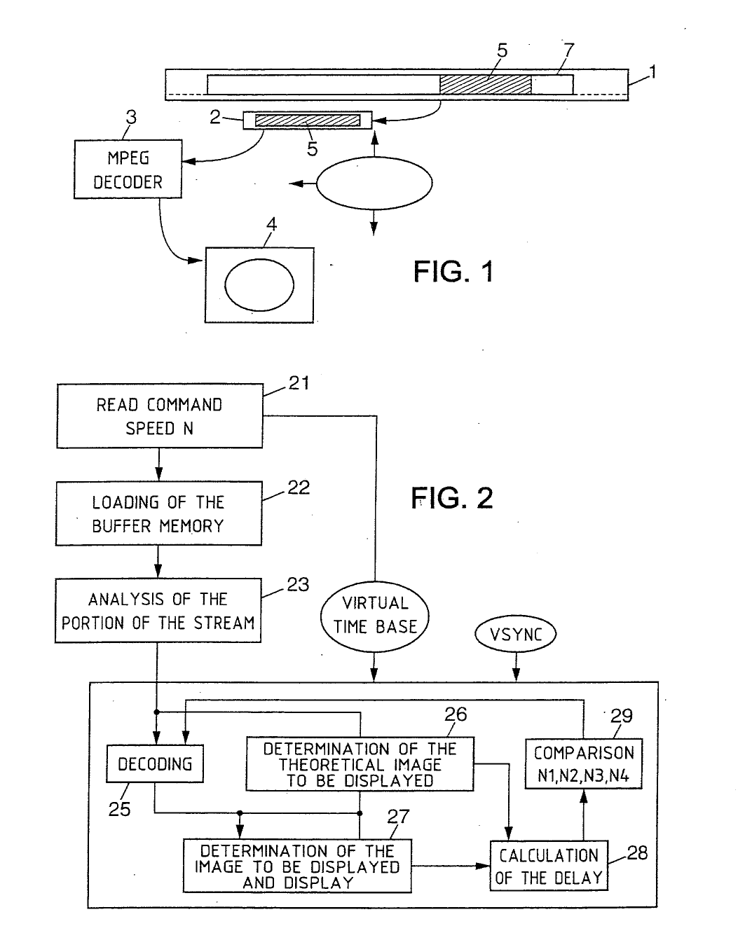

FIG. 1 diagrammatically shows a device for the implementation of the process according to the invention. The device comprises:

a mass storage digital medium 1 such as a hard disk on which is stored a data stream 7 containing pictures coded according to the MPEG standard;

a buffer memory 2 for storing a portion 5 of the compressed data stream after reading from the hard disk 1;

a video decoder 3, in particular an MPEG decoder which is capable of decoding an MPEG picture defined in particular by its position in the buffer memory 2;

a display module 4, adapted for reading the decoded pictures and translating them into the format used for display, for example the PAL, SECAM or NTSC format. It furthermore allows the selection of the fields in the case of interleaved pictures,

a control unit 10 which supervises the operation of the device and which controls the decoder 3 and the display module 4.

The unit 10 applies the following rules as a function of the value of a display delay (the calculation of which is made explicit hereinbelow):

RULE A: at each display instant, that one of the decoded pictures which are available for display and come before theoretical picture corresponding to the instant of display in the order of display of the pictures at the nominal speed, which is the closest to the theoretical picture according to the order of display is displayed;

RULE B: if the display delay is less than or equal to a threshold N1, all the pictures are decoded;

RULE C: if the display delay is greater than N1 and less than or equal to a threshold N2, the B type pictures are not decoded and are not displayed;

RULE D: if the display delay is greater than N2 and less than or equal to a threshold N3, the B type pictures, some at least of the P type pictures, and also the pictures predicted from these P type pictures are not decoded and are not displayed;

RULE E: if the display delay is greater than N3 and less than or equal to a threshold N4, the I type pictures alone are decoded and displayed;

RULE F: if the display delay is strictly greater than N4, a skip is made in the data to be decoded.

The steps of the method according to the invention will now be set forth with reference to the chart of FIG. 2.

The method starts with the reception 21 of a command to read in forward mode, at a theoretical speed xN, the pictures contained in the stream 7 stored on the hard disk 1. In a step 22, the buffer memory 2 is loaded with a first portion 5 of the compressed data stream containing the pictures coded according to the MPEG standard. A phase of analysis 23 of the portion of stream 5 comprises the identification in particular of the start codes allowing the decoding of the GOPs (group of pictures) within the meaning of the MPEG standard, and making it possible to define the type I, P or B of the pictures and the presentation time stamp (or PTS) within a GOP associated with each of the pictures.

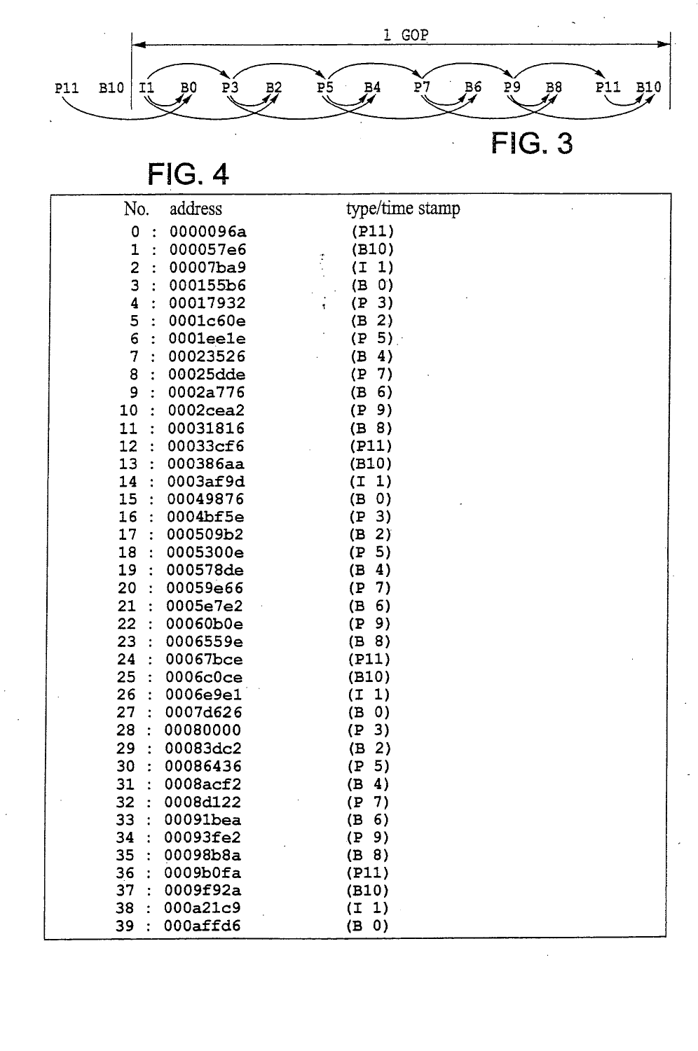

FIG. 3 represents the pictures constituting a GOP of 12 pictures and the prediction links between the pictures of this GOP. Each picture of the GOP is identified by its type I, P or B and by a number lying between 0 and 11 corresponding to its PTS stamp which determines its order of forward display at a nominal speed (x1) within the GOP. Thus B0 is a type B picture which must be displayed first among those of the GOP; then come in the order of forward display I1 (type I picture), then P3 (type P picture), followed by B4 and more. The origin of an arrow marks a reference picture, and the tip of the arrow indicates the picture predicted from this reference picture. Thus B0 is predicted from the picture P11 of the previous GOP, and furthermore from the picture I1 of the GOP represented. I1 is a so-called “intra coded” picture. B2 is predicted from P3 and I1. P3 is predicted from I1, P5 from P3 and more.

The array of FIG. 4 depicts an exemplary portion 5 of compressed data stream having formed the subject of the analysis phase 23. This portion comprises 40 pictures, identified in the array by an index number lying between 0 and 39, which is intended to facilitate reading. The first column contains this index number. The second column contains the address in the buffer memory 2 of the beginning of the data relating to the compressed picture identified by the index number of the first column. The third column contains the type of picture and the time stamp, which indicates the index number (for display at the nominal speed) in the GOP to which the relevant picture belongs.

In the example considered in FIG. 4, the pictures contained in the portion of the stream 5 belong to a certain number of GOPs of similar structure to that represented in FIG. 3. Moreover, the beginning of the decodeable pictures is situated at picture number 2 of the list, which is the picture I1 of the first whole GOP. This intra-coded picture makes it possible to decode some at least of the pictures of the GOP of which it forms part, from picture No. 3 (B0) to picture No. 12 (P11). The pictures are depicted here in the order of decoding and not the order of display.

If the initial theoretical display speed V is equal to xN, then the virtual time base is N past pictures per VSYNC, this amounting to displaying one picture every N pictures at each VSYNC event. If VSYNC(0) denotes the vertical synchronization event corresponding to the displaying of picture No. 2 (image I1), it is expedient to display, according to theoretical virtual time base at the p-th synchronization event onwards of VSYNC(0) denoted VSYNC(p), the (Nxp)-th picture coming after I1 in the order of display, at the nominal speed (x1).

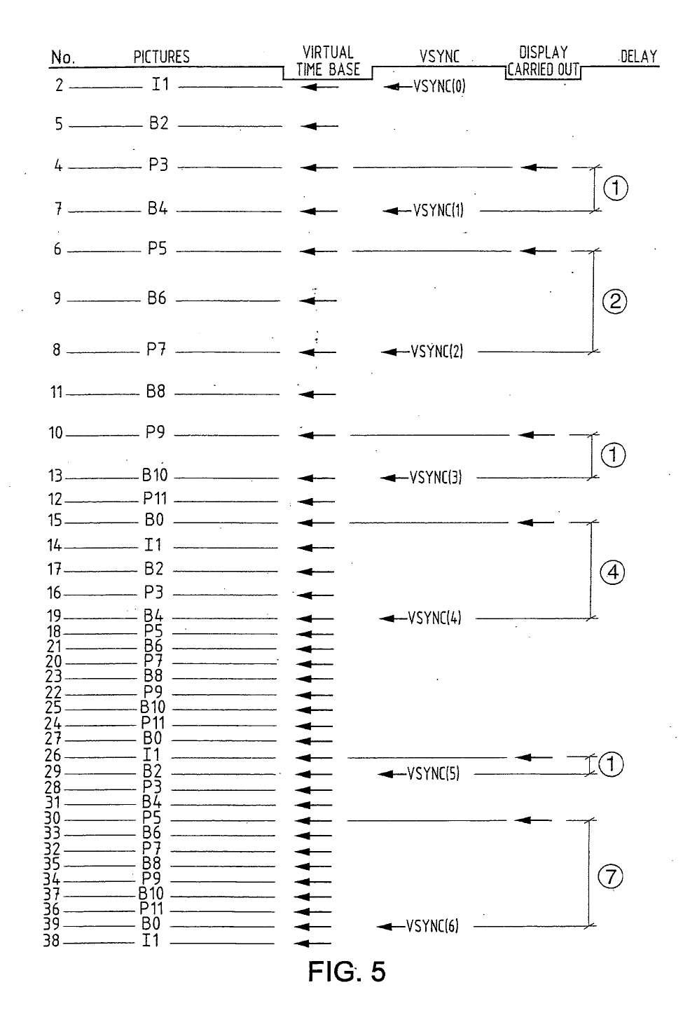

FIG. 5 represents the pictures decoded onwards of the picture No. 2 (image I1), but in the forward order of display. The first column contains the index number associated with this picture according to the first column of the array of FIG. 4. The second column indicates for each picture the type and the index number in its GOP. The third column contains horizontal arrows, which indicate the events of the virtual time base: there are N events according to the virtual time base for a VSYNC (the time between two VSYNCs being constant for example 0.04 s). The fourth column contains horizontal arrows in the rows corresponding to theoretical picture displayed according to theoretical speed V, at the VSYNCs. The fifth column contains horizontal arrows in the rows corresponding to the picture actually displayed at each VSYNC. Finally, the sixth and last column contains vertical lines which give a representation of the delay at each event of the display time base, and the numbers in the circles indicate the delay in terms of number of pictures, as calculated hereinbelow.

Thus, the decoding is carried out in a step 25 (FIG. 2) sequentially over the entire set of pictures, in forward mode.

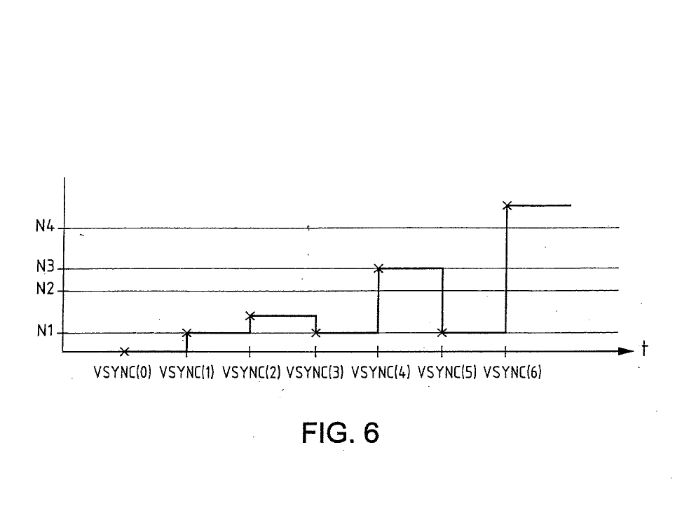

Represented along the ordinate in the graph of FIG. 6 is the value of the delay at instants VSYNC(1) to VSYNC(6), with respect to the thresholds N1, N2, N3 and N4 in the decoding and display operations considered in an exemplary implementation of the process set forth hereinbelow according to the invention.

At the instant VSYNC(1), the picture to be displayed according to theoretical speed xN is determined in a step 26 according to the virtual time base. This is picture No. 7 (B4), in the case where theoretical speed adopted is for example equal to x3.

Now, after the decoding of picture I1, the decoder must perform, in this order, the decoding of picture No.4 (P3) required to decode B2, then of picture No. 5 (B2), and of picture No. 6 (P5), before being able to decode B4. In the example considered, at the instant VSYNC(1), the picture currently being decoded is picture No. 5 (B2) and picture No. 7 (B4) is not yet decoded. This is why in a step 27, at the instant VSYNC1, the picture which is decoded and available for display is displayed, this picture coming before picture No. 7 (B4) in the order of display at the nominal speed, and being closest to picture No. 7 (B4). Here this is picture No. 4 (P3), which is available since it is useful in the decoding of B2.

The virtual time base represented in the third column of the array of FIG. 5 is based on a theoretical parameter of three past pictures per VSYNC, i.e. pictures No. 5, 4 and 7 (respectively B2, P3 and B4). Stated otherwise, theoretical time base is defined here by the parameter M/Q with M=3 and Q=1.

According to this theoretical time base, the picture to be displayed at VSYNC(1) ought to be, as indicated by the fourth column of the array of FIG. 5, picture No. 7 (B4). The picture actually displayed is identified by the arrow of the fifth column of the array, pointing to picture No. 4 (P3).

The delay of the display with respect to theoretical speed is calculated next, in a step 28. It is equal in this case to one picture (B4) and is represented in the sixth column of the array of FIG. 5.

Next, in a step 29, the delay is compared with four thresholds N1, N2, N3 and N4, which in an example are respectively one picture, three pictures, four pictures and seven pictures. In the example considered, the delay is not strictly greater than the first threshold N1. This is why all the pictures continue to be decoded and displayed, according to RULE B indicated hereinabove.

The decoding 25 continues. At the instant VSYNC(2), a new step 26 takes place in which the calculation of the next picture to be displayed according to theoretical time base is realized. This is the third picture to be displayed after picture No. 7 (B4) i.e. picture No. 8 (P7). Now, between VSYNC(1) and VSYNC(2), the decoder has terminated the decoding of picture No. 5 (B2), then that of picture No. 6 (P5), and is currently decoding picture No. 7 (B4) on the basis of pictures No. 4 and No. 6, i.e. P3 and P5 respectively. At the instant VSYNC (2), picture No. 8 (P7) is not yet available. The closest picture in the order of display at the nominal speed is picture No. 6 (P5), which will therefore be displayed. The delay is two pictures and is therefore equal to the threshold N2. RULE C will therefore now be applied. The predicted pictures of type B will no longer be decoded or displayed.

The picture to be displayed at the instant VSYNC(3) according to theoretical speed xN is picture No. 13 (B10). The decoding continues: picture No. 8 (P7), then picture No. 10 (P9) are decoded. picture No. 9 (B6) is not decoded. At the instant VSYNC(3), picture No. 12 (P11) is currently being decoded. Picture No. 10 (P9) is therefore displayed. The delay is now only one picture. The case of RULE B holds and the decoding of the entire set of pictures can resume.

It is assumed that the user then increases theoretical speed of display, which goes to x6, this signifying that theoretical time base is defined by the parameter M/Q with M=6 and Q=1. Thus, the picture to be displayed at the instant VSYNC(4) is picture No. 19 (B4). The decoding 25 continues on picture No. 13 to No. 15. At the instant VSYNC(4), picture No. 16 (P3) is currently being decoded. Moreover, then decoded picture closest to picture No. 19 (B4) is picture No. 15 (B0). The delay is four pictures. RULE D will therefore now be applied.

It is assumed that theoretical speed of display is again increased and goes to x10. The parameter M/Q is such that M=10 and Q=1. The picture to be displayed at the instant VSYNC(5) is picture No. 29 (B2). The decoding continues on pictures No. 14 (type I picture), the B pictures are not decoded and picture No. 16 (P3) as well therefore as the type P pictures predicted from P3, i.e. pictures No. 18, 20, 22, 24 are not decoded. Picture No. 26 (I1), then picture No. 28 (P3) is decoded.

At the instant VSYNC(5), picture No. 29 (B2) is not decoded. It is therefore picture No. 26 (I1) which is displayed since it is the decoded picture available for display which has to be displayed in the forward order at nominal speed before picture No. 29 (B2) which is the closest to picture No. 25. The delay is one picture. All the pictures will be decoded again. The decoding is carried out on pictures No. 29, 30 and 31.

At the instant VSYNC(6), the decoding is currently in progress on picture No. 31 while No. 39 ought to be displayed. The delay is 8 pictures and exceeds the threshold N4 (case e/). A picture skip is therefore performed in the data to be decoded with the aim of reaching the next picture to be displayed, i.e. picture No. 49. This picture does not feature in the stream portion 5 contained in the frame memory 2. It is therefore necessary to perform a skip in the reading of the data of the compressed data stream which are stored on the disk. As no information is available for locating the corresponding picture on the disk, an evaluation of its location is carried out by skipping a quantity of data equal to the number of pictures to be skipped multiplied by the mean bit rate of reading from the hard disk.

It has been noted in practice that, in conventional applications, for speeds of between 0 and x2, the decoder is capable of decoding all the pictures and of displaying them in due time. For speeds of between x2 and x6, the B pictures are skipped since the delay generally exceeds one picture. For speeds between x6 and x10, type P pictures are skipped. For speeds greater than x10, if the delay is not regulated by the act of displaying only I pictures, skips are performed in the data to be decoded.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A method for decoding and displaying MPEG pictures in forward speed mode set at a specified theoretical speed, the method comprising:
evaluating in real time, at a specified display instant, a delay of pictures in a compressed audio-visual data stream, wherein the delay is set to a specified theoretical speed and the pictures in the data stream are coded according to a MPEG standard to include predictive pictures;
if the delay is less than a first specified threshold, then decoding all the pictures of the data stream;
if the delay is greater than the first specified threshold, then no longer decoding at least some of the predicted pictures of the data stream; and
at each display instant, displaying that one of decoded pictures which is available for display and that comes before a theoretical picture corresponding to a display instant in an order of display of pictures at a nominal speed, which is closest to the theoretical picture according to the order of display.

2. The method according to claim 1, wherein the predicted pictures comprise type B pictures, and if the delay is greater than the first threshold, the type B predicted pictures are no longer decoded and no longer displayed.

3. The method according to claim 2, wherein the predicted pictures comprise type P pictures, and if the delay is greater than a second threshold, at least some of the type P predicted pictures, and the pictures predicted from the type P pictures, are no longer decoded and no longer displayed.

4. The method according to claim 3, wherein the predicted pictures comprise type I pictures and wherein if the delay is greater than a third threshold, only the type I pictures are decoded and displayed.

5. The method according to claim 4, wherein if the delay is greater than a fourth threshold, a forward skip is performed in the data stream.

6. The method according to claim 1, wherein the delay is defined as a number of pictures' worth of delay, using a virtual time base clamped with regard to vertical synchronization events of a video display, by comparing a picture displayed with that which ought to be displayed in accordance with the virtual time base.

7. The method according to claim 5, wherein the data stream is stored on a mass storage digital medium and a number of bytes of the data stream which are forward skipped when reading the data stream from the mass storage digital medium is determined by a number of pictures' worth of delay and by a mean bit rate when reading the data stream from the mass storage digital medium.

8. The method according to claim 6, wherein the virtual time base is defined by a parameter equal to a theoretical number of past pictures per vertical synchronization event of the video display.

9. The method according to claim 1, according to which the speed of display is controlled by a user, and is one of the nominal speed and an accelerated speed with respect to the nominal speed.

10. The method according to claim 8, wherein a parameter equal to theoretical number of past pictures per vertical synchronization event is of the type M/Q where M and Q are integers and where the fraction M/Q is reduced.

11. A device for decoding and displaying MPEG pictures in forward speed mode set at a specified theoretical speed, the device comprising:
means for evaluating in real time at a specified display instant, a delay of pictures in a compressed audio-visual data stream, wherein the delay is set to a specified theoretical speed and the pictures in the data stream are coded according to a MPEG standard to include predictive pictures;
means for decoding all the pictures of the data stream if the delay is less than a first specified threshold;
means for no longer decoding at least some of the predicted pictures of the data stream if the delay is greater than the first specified threshold; and
means for displaying, at each display instant, that one of decoded pictures which is available for display and that comes before a theoretical picture corresponding to a display instant in an order of display of pictures at a nominal speed, which is the closest to the theoretical picture according to the order of display.

12. The device according to claim 11, wherein the predicted pictures comprise type B pictures, and if the delay is greater than the first threshold, the type B predicted pictures are no longer decoded and no longer displayed.

13. The device according to claim 12, wherein the predicted pictures comprise type P pictures, and if the delay is greater than a second threshold, at least some of the type P predicted pictures, and the picture predicted from the type P pictures and no longer displayed.

14. The device according to claim 13, wherein the predicted pictures comprise type I pictures and if the delay is greater than a third threshold then decoding only the type I pictures.

15. The device according to claim 14, characterized in that it comprises means for performing a forward skip in the data stream if the delay is greater than a fourth threshold.

16. The device according to claim 11, wherein the delay is defined as a number of pictures' worth of delay, using a virtual time base clamped with regard to vertical synchronization events of a video display by comparing the picture displayed with that which ought to be displayed in accordance with the virtual time base.

17. The device according to claim 15, wherein the data stream is stored on a mass storage digital medium and a number of bytes of the data stream which are forward skipped when reading the data stream from the mass storage digital medium is determined by a number of pictures' worth of delay and by a mean bit rate when reading the data stream from the mass storage digital medium.

18. The device according to claim 16, wherein the virtual time base is defined by a parameter equal to a theoretical number of past pictures per vertical synchronization event of the video display.

19. The device according to claim 11, wherein the speed of display is controlled by a user, and is one of the nominal speed and an accelerated speed with respect to the nominal speed.

20. The device according to claim 18, wherein the parameter equal to theoretical number of past pictures per vertical synchronization event is of the type M/Q where M and Q are integers and where the fraction M/Q is reduced.

21. A video driver circuit for decoding and displaying MPEG pictures in forward speed mode set at a specified theoretical speed, the device comprising:
means for evaluating in real time at specified respective display instants, a delay of the pictures in a compressed audio-visual data stream, wherein the delay is set to a specified theoretical speed and the pictures in the data stream are coded according to the MPEG standard to include predictive pictures;
means for decoding all the pictures of the data stream if the delay is less than a first specified threshold;
means for no longer decoding at least some of the predicted pictures of the data stream if the delay is greater than the first specified threshold; and
means for displaying, at each display instant, that one of decoded pictures which is available for display and that comes before a theoretical picture corresponding to a display instant in an order of display of a pictures at a nominal speed, which is closest to the theoretical picture according to the order of display.

22. A set-top box for decoding and displaying MPEG pictures in forward speed mode set at a specified theoretical speed, the device comprising:
means for evaluating in real time at specified respective display instants, a delay of the pictures in a compressed audio-visual data stream, wherein the delay is set to a specified theoretical speed and the pictures in the data stream are coded according to a MPEG standard to include predictive pictures;
means for decoding all the pictures of the data stream if the delay is less than a first specified threshold;
means for no longer decoding at least some of the predicted pictures of the data stream if the delay is greater than the first specified threshold; and
means for displaying, at each display instant, that one of decoded pictures which is available for display and that comes before a theoretical picture corresponding to a display instant in an order of display of a pictures at a nominal speed, which is closest to the theoretical picture according to the order of display.
